(19) United States
(12) Patent Application Publication
(10) Pub. No.: US 2026/0296606 A1
(43) Pub. Date: Oct. 1, 2026

(54) Anti-Fouling System

(71) Applicant: BIOREN TECNOLOGIA S.A., Rio de Janeiro (BR)

(72) Inventors: Roberto Kessel, Rio de Janeiro (BR); Carlos Alberto Carloni, Rio de Janeiro (BR); Luiz Gustavo Vieira Coelho Cidade, Rio de Janeiro (BR); Lucas Raad de Oliveira, Rio de Janeiro (BR); Fredy Giovany Osorio Gutierrez, Rio de Janeiro (BR)

(21) Appl. No.: 19/479,235

(22) PCT Filed: Apr. 24, 2024
(86) PCT No.: PCT/BR2024/050168

§ 371 Date: Oct. 27, 2025

(30) Foreign Application Priority Data
Apr. 28, 2023 (BR) 102023008294-7
Apr. 8, 2024 (BR) 1020240068386

(51) Int. Cl. B63B 59/04; C02F 1/00; C02F 1/48

(52) U.S. Cl. CPC B63B 59/04; C02F 1/008; C02F 1/487; C02F 2209/005; C02F 2303/08; C02F 2303/20

(57) ABSTRACT

The present invention is related to an anti-fouling system, which comprises: a PLC (100) configured for generating a random signal and provide the random signal to an element (220) to be protected; an amplifier (120) in contact with the PLC (100); and an inductor (130) in contact with the amplifier (120), wherein the amplifier (120) is configured to receive the random signal generated, amplify the random signal and send the random signal to the inductor (130), wherein the inductor (130) is configured to receive the random signal from the amplifier (120) and provide the random signal to element (220), wherein the random signal comprises a frequency which varies randomly within a frequency range.

The present invention is related to an anti-fouling system for repelling, avoiding and/or interrupting the development of biofoulings on underwater elements. In particular, the present invention is related to an anti-fouling system which generates electromagnetic fields by means of random electrical signals for protecting underwater elements against the buildup of biofoulings.

### Description of State of the Art

Elements which have underwater surfaces such as vessels, ocean platforms, marine structures, among others, have always been significantly affected by the development of biofoulings on the surfaces thereof. The development of biofoulings, such as, for example, microorganisms, plants, algae and/or animals in these structures results in the most diverse problems, including losses related to the increase of trawling on vessels, structural damage on marine structures, increase of maintenance cost, etc., in addition to severe environmental impacts such as, for example, the significant increase of greenhouse gases.

Throughout time, many solutions were developed with the intention of avoiding the development of fouling or removing same from underwater surfaces. Many of these solutions are ecologically harmful, such as paints which release biocides and specific microplastics. Other solutions are too complex to be viable operationally or economically.

A solution proposed by the state of the art is described in document U.S. Pat. No. 6,209,472. In this document is described an apparatus developed for inhibiting the development of biofoulings in ship hulls through transmission of electrical pulses to the underwater surfaces of the vessel.

In this case, however, the system requires that the vessel has a specific construction, wherein the sides (edges) of the hull are divided by an insulating element. This need makes the installation of a system in vessels that already exist impossible and increases considerably the complexity of the project even for a new vessel. In addition, by using electrical pulses with preset variable parameters, that is, a non-random pulse, the efficiency of the inhibition of biofoulings is reduced. This is because the biofoulings are highly adaptable, and, after a determined period, they get used to the new conditions imposed and incrust the ship/structure again. Additionally, the basis of the invention is the control over the size of the electrolysis bubbles, so that they remain close to the hull substrate. We know that the control of electrolysis is neither simple nor technically and commercially viable. Carrying out this electrolysis in an uncontrolled environment, such as the sea, for example, turns out to be technically unfeasible.

Another document of the state of the art which describes an attempt to solve the appearance of biofoulings in underwater bodies is document FR 1319428. In this case, it is described the application of an alternate electrical voltage to a metal underwater surface, wherein this voltage has a frequency which varies between two fixed values (upper limit and lower limit), that is, non-random, in a time variation of 5 s to 30 s. Once more, the efficiency of the inhibition of biofoulings of the device described in the mentioned document is reduced by creating a condition which allows adaptation of the biofoulings as it has predictability over time. Another factor which distinguishes operationally the technology of the cited document from the present invention is the need for the electrodes to be in contact with the surface of the water, hindering the technical and commercial feasibility of the product described in the cited document.

The non-existence of commercial vessels comprising the technologies described above is a possible example of the inefficiencies thereof due to the characteristics of the signals and technical and commercial characteristics of the technology, at a time when this theme is massively discussed worldwide and certainly, if feasible, there would be plenty of space for implementing these solutions.

An evolution of these cited documents is described in document BR 102015012756-1. In this document is described an anti-fouling system which provides a chain of random values to a structure to be protected against biofoulings. The chain is generated from capturing ambient sound, due to the randomness thereof, and transmitted to the surface through amplifiers.

However, the system of document BR 102015012756-1 is described in a simple manner and important technical evolutions have been made from the filing date thereof to now. The same understanding is applied to the technology described in document BR 202019013905-1, of the same inventors.

Thus, it is observed, in the state of the art, a lack of a reliable, simple, efficient system, having reduced one-off impact in the surrounding environment to repel, avoid and/or prevent biofouling from developing and/or establishing themselves on underwater surfaces.

It is also not known in the state of the art systems that make it possible to ally biofouling repellency and simultaneously retard the corrosive effect of surfaces in contact with the liquid medium without the use of paints or toxic products directed to this end.

### Objectives of the Invention

In view of the problems described in the state of the art, the present invention provides a system that is able to repel, prevent, avoid and/or interrupt the development or establishment of fouling on underwater surfaces by creating an uncomfortable environment in the vicinity of these surfaces.

Another purpose of the present invention is to enable the development and/or establishment of biofoulings to be repelled, prevented, avoided and/or interrupted without causing harmful impacts to the aquatic environment wherein the underwater surface is located. The technology action process is caused by the discomfort generated by means of the random variation of the electromagnetic fields resulting from the random electrical signals in the area of application of the technology. In closed systems biofouling beings suffer an evolutive paralyzing effect whereby they cannot metamorphose or settle on the desired surface. In open systems, the biofouling beings merely avoid that substrate and search for another place, more suitable to their settlement and development.

Additionally, a purpose of the present invention is to avoid structural, economic, logistical problems, lack of power efficiency, among others, wherein is included the reduction in the excessive consumption of fuels (fossil and others), emission of greenhouse gases and migration of invading species in ships and similar, by means of the inhibition of biofoulings.

An additional purpose of the present invention is to provide a flexible anti-fouling system, that is, able to be installed/applied in different types of surfaces, different types of materials, different dimensioning, pre-existing surfaces and/or surfaces having different formats.

Another purpose of the present invention is to provide an antifouling system able to be installed/applied in several aquatic conditions, such as marine water, fresh water, isolated deep-water oceanic environments, coves, polluted water, clean water, among others.

Another purpose of the present invention is to inactivate the action of mature fouling, particularly those that are toxic to the local wildlife, by means of the action of the random electrical signals.

Another purpose of the present invention is to generate a delaying effect on the development of corrosion on the surface to be protected. In other words, the purpose is to present an anti-corrosive effect on the surfaces protected against fouling.

### BRIEF DESCRIPTION OF THE INVENTION

The present invention is related to an anti-fouling system, which comprises a PLC configured to generate a random signal and provide the random signal to an element to be protected, wherein the random signal comprises a frequency range between 0.1 Hz and 100 KHz, and a frequency change that occurs in a time interval of less than 1 second. The random signal can comprise a voltage range between-30 V and 30 V. The random signal can comprise a power per application area between 0.01 W/m² and 5 W/m².

The anti-fouling system can further comprise an amplifier in contact with the PLC; and an inductor in contact with the amplifier, wherein the amplifier is configured to receive a random signal generated, amplify the random signal and send the random signal to the inductor, wherein the inductor is configured to receive the random signal from the amplifier and provide the random signal to the element. The amplifier is configured to alter the power of the random signal emitted by the PLC.

The element to be protected can comprise at least one material selected among: metal, plastic, resin material, concrete and/or masonry, for example. The random signal provided to the element to be protected can be provided by induction to an inner portion of the element or by direct application to an outer portion and in contact with the water layer next to a surface of the element. The random signal provided to the element to be protected can be by induction to the inner portion of the element when the surface material is a conductor or by direct application to the outer portion and in contact with the water layer next to the surface of the element when the surface material is insulating. Th random signal provided to the element to be protected can be provided by induction, whereby a negative electrode is positioned directly on the water and a positive element is positioned in contact with the material to be protected. The random signal to be provided to the element to be protected can be provided next to the water layer.

Alternatively, the negative signal can be provided next to the water layer surrounding the material and the positive one on the surface of the conductor material.

### BRIEF DESCRIPTION OF THE DRAWINGS

The present invention will now be described in greater detail, based on a sample of execution represented in the drawings. The figures show:

FIG. 1—a schematic diagram of an embodiment of the antifouling system of the present invention;

FIG. 2—computer simulation of the electromagnetic field generated by an embodiment of the present invention in a first moment;

FIG. 3—computer simulation of the electromagnetic field generated by an embodiment of the present invention in a second moment; and

FIG. 4—illustrative graphic of the technical effect obtained by the present invention over time in comparison with the systems of the state of the art.

### DETAILED DESCRIPTION OF THE INVENTION

In a conceptual manner, the present invention is related to a system for generating random electrical signals, that is randomly, for the protection of underwater elements against fouling. The random electrical signals generated by the system of the present invention provide an electromagnetic field with random variation to create an uncomfortable environment surrounding the underwater surfaces so as to repel, prevent, avoid and/or interrupt the fouling from developing and/or settling on the underwater surfaces.

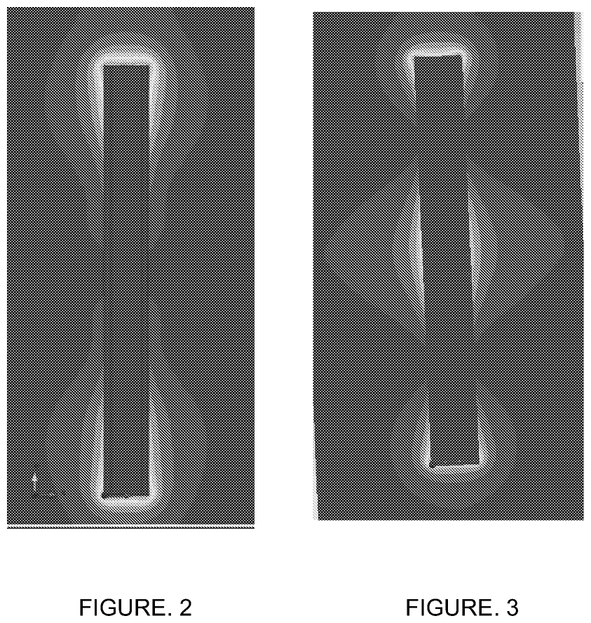

Despite mentioning throughout the text, the protection of the underwater surfaces, which can be understood as a protection in two dimensions, the present invention provides a volume of protection, that is, a protection in three dimensions surrounding the underwater surfaces. This is because the water layer which receives the random electrical signal of the present invention comprises a three-dimensional volume of water. Thus, the use of terms such as field of application or protected area or protected surface must be understood not only in the bidimensional concept thereof, but as a three-dimensional protection which extends beyond the surface in at least a small dimension of the volume of water. FIGS. 2 and 3 illustrate this three-dimensional protection provided by the random signal of the system of the present invention, which generates a random electromagnetic field. FIG. 2 presents the dispersion of the electromagnetic field in an embodiment in a first moment and FIG. 3 presents the dispersion of the electromagnetic field in a second moment subsequent to the first moment. The random alteration of the characteristics of the electromagnetic fields is visible over time, generated by the system of the present invention.

In one embodiment, the distance of the electromagnetic field generated by the random signal from the surface to be protected is comprised between 0 m and 5 m, preferably between 0 m and 2 m, and more preferably, between 0 m and 0.2 m.

The use of random electrical signals (erratic) provides an advantageous technical effect in face of other known systems which use merely variable signals in an alternate manner, which repeat themselves in a determined time window. As is known, a constant in living beings is their remarkable ability to adapt. An environmental condition that is adverse to the proliferation of life is eventually overcome by the ability of the living beings to adapt themselves. In systems that generate variable signals, the beings tend to adapt over time to the new conditions imposed having in mind the predictability of the signal. This is because the alternate variable signal is defined as a signal that varies within a determined range of frequent and predictable values. On the other hand, the variation of the electromagnetic field generated in a random manner does not allow timely adaptation of the living being to the environment. The random signal is a signal which varies in an unknown and uncertain manner, that is, randomly or without specific rules. This randomness of the signal of the present invention provides the anti-fouling technical effect which is neither anticipated nor known by the state of the art.

The tables below exemplify the differences between randomness and variable mentioned above. In the exemplification below (Table 1), the number sequence could be classified as alternate and variable:

TABLE 1

| | | | | | | | | | |
|---|---|---|---|---|---|---|---|---|---|
| 1 | 5 | 7 | 12 | 17 | 3 | 8 | 20 | 9 | 11 |
| 1 | 5 | 7 | 12 | 17 | 3 | 8 | 20 | 9 | 11 |
| 1 | 5 | 7 | 12 | 17 | 3 | 8 | 20 | 9 | 11 |

Another example of variable oscillation is indicated below (Table 2).

TABLE 2

| | | | | | | | | | |
|---|---|---|---|---|---|---|---|---|---|
| 1 | 2 | 3 | 4 | 5 | 6 | 7 | 8 | 9 | 10 |
| 1 | 2 | 3 | 4 | 5 | 6 | 7 | 8 | 9 | 10 |
| 1 | 2 | 3 | 4 | 5 | 6 | 7 | 8 | 9 | 10 |

The oscillations of the above tables could never be considered as being random, since randomness does not allow, even statistically, that any type of pattern be constituted. Observe that the two examples above, despite being variable and alternate, indicate a standardization. It is precisely the lack of standardization, inherent only to randomness, which is able to deliver the expected technical effect, which has as purpose avoiding biofouling in underwater elements. In contrast with the tables above with variable values (Tables 1 and 2), the table below Table 3) exemplifies a sequence of random values.

TABLE 3

| | | | | | | | | | |
|---|---|---|---|---|---|---|---|---|---|
| 1 | 5 | 7 | 12 | 17 | 3 | 8 | 20 | 9 | 11 |
| 14 | 17 | 8 | 9 | 2 | 19 | 7 | 5 | 13 | 11 |
| 1 | 3 | 8 | 20 | 9 | 11 | 6 | 15 | 4 | 18 |

One question which reinforces this difference is the ease which there is in generating a signal with a specific rule for variation of the frequency thereof and an absolutely random signal. Determining a logical rule for a variation that repeats itself alternately is simple, but determining a logical rule for randomness is considerably more complex. Thus, the randomness of the signal of the present invention cannot be considered similar to variable signals neither technically in its generation manner nor in terms of the results obtained.

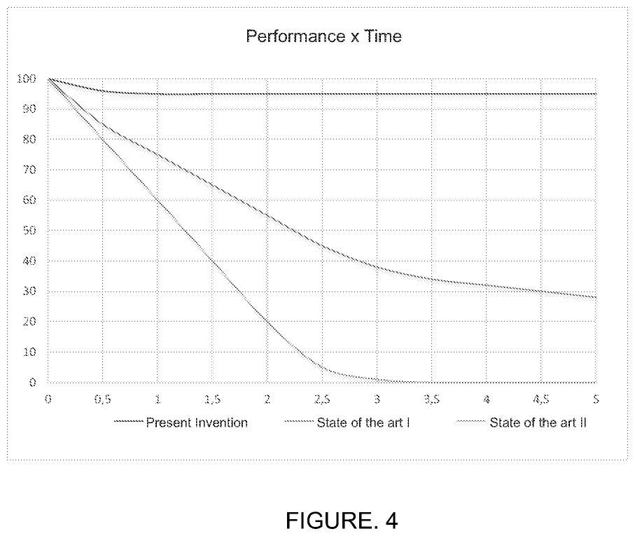

FIG. 4 illustrates the advantage of the randomness of the signal of the present invention over time in face of solutions known to the state of the art. FIG. 4 shows the anti-fouling performance of the solutions over time, the drop in performance of the solutions of the state of the art being visible, while the system of the present invention remains in high performance indefinitely.

The aquatic elements or underwater surfaces wherein the present invention can act by providing a signal with the characteristics which will be described ahead include any type of vessel (ships, launches, etc.), fixed or floating ocean platforms, power generators, industries which require capturing river or sea water, desalination plants, hydroelectric plants, nuclear plants, underwater infrastructures (port, quay, pier, etc.), among others.

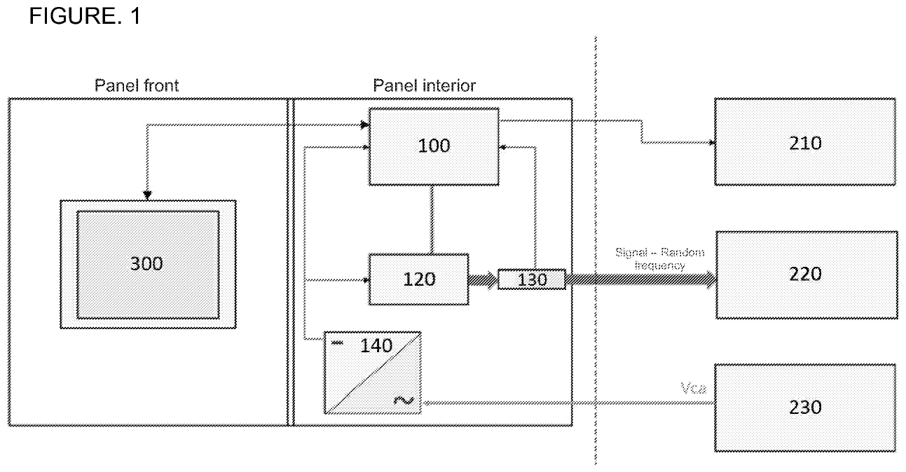

In the embodiment of FIG. 1, the system of the present invention comprises a Programmable Logic Controller (PLC) 100, a Human-Machine Interface (HMI) 300, amplifiers 120, feeding sources 140, and inductors 130. These components of the system are electrically associated between each other, that is, they have electrical connections which allow the transference of voltage between one component and another.

The PLC 100 is responsible for generating and administrating all the necessary signals for the adequate operation of the anti-fouling system. The main function thereof in the system of the present invention is to generate in a random and erratic manner the frequencies which will be sent to the application point. Other functions of the PLC 100 include promoting a Human-Machine Interface and managing the use of the invention. The use of a PLC in the present invention in face of other signal generation elements of the state of the art, provides greater processing ability, thus allowing a better interaction with the user, by means of the HMI. In one embodiment, the HMI is modular, wherein it comprises a processing module and another for inputs and outputs.

In the context of the present invention, the random signal, or simply signal, means a signal which comprises a frequency which varies in a random manner between two threshold limits configured in the PLC 100 and according to the objective of the application, wherein the frequency variation occurs without a specific preset rule and the increase or reduction of the frequency of this signal in the subsequent moment is determined in an unpredictable manner. As a consequence, the random signal generates an electromagnetic field with random characteristics (erratic).

Said characteristic provides a technical effect of creating an inhospitable environment in the aquatic environment wherein the element 220 to be protected is located. Additionally, the random signal is advantageous in face of a merely variable signal, that is, which oscillates the frequency thereof between two threshold values increasing and reducing the frequency in a predictable manner. This is because the merely variable signal creates a condition for adapting to the initially inhospitable environment. Over time, the beings which generate the biofouling adapt to those conditions and the merely variable signal loses its initial purpose. In other words, the efficiency of a random signal in repelling, preventing and/or avoiding biofouling in underwater surfaces is greater than the efficiency of merely variable signals at any term.

In one embodiment, the signal produced by the PLC 100 has low power. In one embodiment, the power used is comprised in the range between 0.01 W/m² and 5 W/m², preferably between 0,025 W/m² and 4 W/m², and more preferably, between 0.05 W/m² and 3 W/m².

In one example of embodiment wherein the application of the random signal requires a lower power, the power per area used is comprised within the range between 0.01 W/m² and 1 W/m², preferably between 0.02 W/m² and 0.5 W/m², and more preferably, between 0.03 W/m² and 0.1 W/m².

In one example of embodiment wherein the application of the random signal requires a higher power, the power per area used is comprised within the range between 0.01 W/m² and 5 W/m², preferably between 0.5 W/m² and 4 W/m², and more preferably, between 1 W/m² and 3 W/m².

In another embodiment, the random signal comprises a power of 1 W to 700 W, preferably, 20 W to 200 W, and, more preferably, 40 W to 60 W for up to 200 m² of surface area of protection.

In one embodiment, the signal generated by the anti-fouling system of the present invention comprises a frequency which varies randomly between approximately 0.1 Hz and 100 KHz, preferably between 1 Hz and 80 KHz, more preferably between 20 Hz and 20 KHz. In another example of embodiment, the signal generated by the anti-fouling system of the present invention comprises a frequency which varies randomly between approximately 20 KHz and 100 KHz, preferably between 30 KHz and 80 KHz, more preferably between 40 KHz and 60 KHz. In yet another example of embodiment, the signal generated by the antifouling system of the present invention comprises a frequency which varies randomly between approximately 0.1 Hz and 1 KHz, preferably between 1 Hz and 80 Hz, more preferably between 20 Hz and 50 Hz.

In one embodiment the signal generated by the anti-fouling system of the present invention comprises a frequency change which occurs in a random time of less than 1 second. In another embodiment, the frequency change occurs randomly in a time span between approximately 50 ms and 1000 ms, preferably between 50 ms and 300 ms, more preferably between 150 ms and 250 ms. In another example of embodiment, the frequency change occurs randomly between approximately 50 ms and 1000 ms, preferably between 400 ms and 800 ms, more preferably between 600 ms and 700 ms.

The random signal of the present invention generated randomly with the frequency ranges and frequency change times indicated above provides an unexpected technical effect of high efficiency in repelling, preventing and/or interrupting the development or establishment of biofouling on the underwater surface of the element 220 to be protected. There are no known systems able to achieve the unexpected technical effect reached by the random signal of the present invention.

The PLC 100 comprises retentive addresses which allow values read and events that have occurred to remain stored in the PLC 100 even without external feeding. In this way, even if the anti-fouling system is inadvertently turned off, the date and hour of the eventual disconnection will be stored, as well as the moment when the anti-fouling system was reconnected. In this manner, the PLC 100 enables an advantageous signal management in face of other systems of the state of the art. The information stored in the PLC 100 allows analyzing the working of the equipment and the performance thereof in the structure being applied.

In one embodiment, the PLC 100 is able to implement a management of equipment failures, generating distinct alarms, and storing them (history of alarms). The hour meter, record of working time, is carried out by PLC 100, which brings safety to the system as a whole. The PLC enables the presence of an interface, via communication protocol, with external equipment, such as, for example, the alarm and supervisory system of the vessel. That is, the PLC 100 has as secondary functions: more sophisticated interaction with users, failure management, hour meter and interface via digital communication with external equipment (for example, supervisory systems).

In one embodiment, the PLC 100 comprises a digital output (dry contact) for activating an external alarm system 210. The external alarm system 210 is an additional component of the anti-fouling system of the present invention connected to the PLC 100, which emits a visual or audible warning to the system operator (user) of problems related to the system. The external alarm device 210 can be, for example, a siren, a gyroscope, a signal tower, among others. The output in “dry contact” is a potential-free contact, that is, completely isolated (galvanic isolation) from the rest of PLC 100. This characteristic avoids that any problem in the external alarm device 210 or even in the cabling between the control panel and the external alarm device 210 causes any damage to the PLC 100.

In one embodiment, the PLC 100 is fed with suitable voltage and has configurable digital inputs according to the application need. It also comprises rapid digital outputs supporting frequencies up to 100 KHz.

In a more specific example of embodiment, but not limitative, the PLC 100 is fed with 24 VCC and has 8 digital inputs, set up according to the application need. It also comprises 4 digital NPN outputs, being 2 rapid outputs supporting frequencies up to 100 KHz. The system can, for example, apply the signal for protecting the hull of a commercial ship.

In an alternative embodiment, the system of the present invention comprises a microcontroller for performing the signal generation alternatively to the PLC 100. In this embodiment, the microcontroller can carry out the functions described for the PLC with the same efficiency and obtaining the advantages and technical effects already described.

Apart from the generators of random signals already mentioned, the system of the present invention can comprise random signal generators which are not yet known by the current technology level, but which will be developed and can generate the same technical effect of the components herein described.

The HMI 300 of the anti-fouling system is responsible for providing management information, which is protected with indications related to connections and information of the external alarm device 210. The HMI 300 is basically an information source about the anti-fouling system for the operator. This characteristic brings safety to the operator about the working of the system.

Additionally, the HMI 300 allows access to other information related to the anti-fouling system. For example, it is able to provide information related to history of events and also hour meters, which indicate the operating time of the anti-fouling system and also the time that the anti-fouling system remained disconnected.

In one embodiment, the HMI 300 comprises a main screen which comprises buttons for accessing the remaining screens, whether the history of alarms emitted by the external alarm device 210, the active alarms one, the hour meter one, etc.

In one embodiment, the HMI is a touchscreen.

In one embodiment, the anti-fouling system comprises the amplifiers 120. In certain practical applications of the present invention, the PLC 100 cannot produce a signal with sufficient power to be applied directly on element 200 to be protected. In these cases, it would not be possible to obtain the desired technical effect of protecting a sea chest or vessel hull. The amplifiers 120 have the purpose of receiving the signals originating from the PLC 100 and amplifying the power of these signals before they are applied through the inductors 130 to the elements 220 to be protected against biofouling. Thus, the amplifiers 120 are configured to receive the random signal generated by PLC 100, amplify the random signal, and send the random signal to the inductors 130.

In one embodiment, the amplifier 120 is an electronic card.

In one embodiment, the amplifiers 120 can be manually adjusted by the operator.

In one embodiment, the anti-fouling system comprises feeding sources 140. The feeding sources 140 are responsible for providing the necessary energy for the correct working of the equipment of the anti-fouling system.

In one embodiment, the feeding sources 140 can receive a voltage (alternate current) from external sources 230. In this case, the feeding sources have the function of conditioning the external feeding of the external sources 230 to the components of the system of the present invention. That is, in this embodiment, the feeding sources are converters, which convert an input voltage with alternate current to an output with continuous current, with the suitable voltage for feeding the active components of the system.

In one embodiment, the voltage used is comprised in the range between −30 V and 30 V, preferably between −20 V and 20 V, and more preferably between −12 V and 12 V.

In one embodiment, the external source 230 is the power network of the vessel 230. In another embodiment, the external sources 230 are solar panels. Other examples of external power sources can be used in the embodiment which includes external sources 230.

In one embodiment, the anti-fouling system comprises inductors 130. The inductors 130 are coupling elements connected to the system between the output of the amplifiers 120 and the application point of the random signals. The inductors 130 vary the electric current which is applied to element 220 to be protected. The inductors 130 reduce the current with the increase of frequency, increasing the randomness character of the signal.

In one embodiment, the system of the present invention further comprises a failure alarm. The failure alarm provides a visual or audible warning in case of absence of feed current in the system, broken cables among the amplifiers 120 and the respective inductors 130 and/or broken cables between the connection points of the application points of the random signals in element 220 to be protected.

For the anti-fouling system of the present invention, the manner of applying the signals can be made in different forms depending on the characteristics of element 220 to be protected against biofouling and/or the aquatic environment wherein element 220 to be protected is located.

In one embodiment, the application of the random signal in element 220 to be protected against biofouling is made by induction through the internal portion of element 220, for example, interior of a buoy or the hull of a vessel, directly on element 220 to be protected and the protection obtained is provided on the outer portion in contact with the water.

In another embodiment, the application of the random signal is made by direct application, that is, the random signal is applied on the outer portion and in contact with the aquatic environment of element 220 to be protected against biofouling.

The element 220 to be protected by the system of the present invention and the contact surfaces thereof with the aquatic environment can comprise different materials. Since the random signal provided to element 220 to be protected affects the aquatic environment, the material itself is not an impediment to generating the anti-fouling effect, since what matters is the surface water layer receiving the random signals generated by the anti-fouling system. Examples of materials which can compose the element 220 to be protected include: metal surfaces, plastic surfaces, resin material surfaces, concrete surfaces, masonry surfaces, among others. That is, any type of material can compose the surface of element 220 to be protected, as long as said surface is in contact with the water.

The material of the surface to be protected will affect the method of applying the signal and of using the system of the present invention. For surfaces of conductor materials, the electrodes can be placed directly on the structure, wherein the electromagnetic fields on the water are generated from an inductive process; or a negative electrode is directly positioned on the water and a positive electrode is positioned in contact with the material to be protected. For non-conductor materials, water is used as conductor of the random current. For this, the electrodes must be positioned for application next to the water layer so that the circulation of the random current occurs solely through the water.

It must be noted that the different examples of embodiments described in the present specification can be combined in different manners to result in the anti-fouling system of the present invention and obtain the particular advantages mentioned for each characteristic.

Having described examples of embodiments, it must be understood that the scope of the present invention covers other possible variations, being limited only by the contents of the attached claims, there being included therein the possible equivalents.

1-9. (canceled)

10. An anti-fouling system comprising:
a Programmable Logic Controller, (PLC) or a microcontroller configured to generate a random signal and provide the random signal to an element to be protected; and
an amplifier in contact with the PLC or microcontroller configured to alter the power of the random signal emitted by PLC or microcontroller, wherein the random signal is provided to an inner portion of the element to provide protection on an outer portion of the element that is in contact with the water, wherein the random signal comprises a frequency range between 0.1 Hz and 100 KHz, a frequency change which occurs in a random time of less than 1 second, a voltage range between −12 V and 12 V, and a power per area of application between 0.01 W/m² and 5 W/m².

11. The anti-fouling system according to claim 1, further comprising an inductor in contact with the amplifier, wherein the amplifier is configured to receive the random signal generated, amplify the random signal, and send the random signal to the inductor, wherein the inductor is configured to receive the random signal from the amplifier and provide the random signal to the element.

12. The anti-fouling system according to claim 1, wherein the element to be protected comprises at least one material selected from: metal, plastic, resin material, concrete and/or masonry.

13. The anti-fouling system according to claim 2, wherein the element to be protected comprises at least one material selected from: metal, plastic, resin material, concrete and/or masonry.

14. The anti-fouling system, according to claim 1, wherein the element to be protected is a hull of a vessel.

15. The anti-fouling system, according to claim 2, wherein the element to be protected is a hull of a vessel.

16. The anti-fouling system, according to claim 3, wherein the element to be protected is a hull of a vessel.
